(19) United States
(12) Patent Application Publication
(10) Pub. No.: US 2025/0024343 A1
(43) Pub. Date: Jan. 16, 2025

(54) DYNAMIC RADIO RESOURCE MANAGEMENT

(71) Applicant: Telefonaktiebolaget LM Ericsson (publ), Stockholm (SE)

(72) Inventors: Mohammed ZOUROB; Magnus SANDGREN; Gang ZOU; Andreas KRISTENSSON; Andres REIAL

(73) Assignee: Telefonaktiebolaget LM Ericsson (publ), Stockholm (SE)

(21) Appl. No.: 18/580,320

(22) PCT Filed: Jul. 19, 2021
(86) PCT No.: PCT/EP2021/070145

§ 371 Date: Jan. 18, 2024

(51) Int. Cl. H04W 36/32

(52) U.S. Cl. CPC H04W 36/322

(57) ABSTRACT

A method for improved Radio Resource Management (RRM) for a User Equipment, UE, (100) operating in a network (200) comprising one or more first User Equipments (100), a second User Equipment (100-2) and a network node (210. 220), the method comprising: determining a dependency between the one or more first UEs (100) and the second User Equipment (100-2); determining RRM settings for the second User Equipment; and determining RRM settings for the one or more first UEs (100) based on the RRM settings for the second User Equipment (100-2).

### TECHNICAL FIELD

The present invention relates to an arrangement comprising computer software modules, an arrangement comprising circuits, a user equipment, a network and a method for providing improved dynamic radio resource management, and in particular to an arrangement comprising computer software modules, an arrangement comprising circuits, a user equipment, a network and a method for providing improved dynamic radio resource management at future locations and/or for user equipment having limited capabilities.

### BACKGROUND

A Base Station (BS) always tries its best to accommodate all the requests from the different UEs (User Equipment), whether it is for joining a network (NW), call initiation, handovers, transmissions/receptions and much more. For that, the BS needs to manage its most valuable resource efficiently, the radio frequency spectrum. The management of several NW parameters is called Radio Resource Management (RRM). RRM refers to system level management of radio resources, co-channel interference and other radio transmission characteristics in wireless communication systems, such as wireless sensor systems, wireless local area networks, radio broadcasting networks, and cellular networks. RRM involves algorithms and strategies to control parameters such as handover criteria, beamforming, data rates, modulation scheme, user allocation, error coding scheme, transmit power, . . . etc. The aim is to efficiently make use of the radio network infrastructure and limited radio-frequency spectrum resources as much as possible.

Two distinctive RRM schools exist: Static RRM and Dynamic RRM. Dynamic RRM schemes flexibly change the radio network parameters in response to the user positions, user mobility, base station density, traffic load, quality of service requirements, . . . etc. Dynamic RRM schemes are utilized in wireless systems design, in order to attain tighter frequency reuse and minimize expensive manual cell planning, leading to enhanced spectral efficiency of the system.

Some schemes are centralized while some other are distributed. In centralized schemes, a number of access points and base stations are controlled by a Radio Network Controller (RNC). In distributed schemes, either coordinated by exchanging information among wireless access points or base stations, or as autonomous algorithms in these stations.

Examples of dynamic RRM schemes are:
Dynamic Frequency Selection (DFS) algorithms or Dynamic Channel Allocation (DCA)
Precoding algorithms
Power control algorithms
Link adaptation algorithms
Traffic adaptive handover criteria
Re-use partitioning
Adaptive filtering
Dynamic diversity schemes (Soft handover, Dynamic single-frequency networks (DSFN), Phased array antenna with
   Space-time coding
   Multiple-input multiple-output communications (MIMO)
   Beamforming
Admission control
Mobile ad hoc networks using multi-hop communication
Femtocells
Dynamic bandwidth allocation using statistical multiplexing or resource reservation multiple access schemes
Channel-dependent scheduling
Green communication
Cognitive radio
Quality of service (QOS) aware RRM

Another type of RRM is Inter-cell RRM. Networks like the LTE (Long Term Evolution) standard (defined by 3GPP) targets a frequency reuse of one. Therefore, neighboring cells in such networks use the same frequency spectrum. Space Division Multiple Access (SDMA) is exploited by such systems to achieve high efficiency in terms of spectrum, however, at the expense of mandating close coordination between cells in order to minimize inter-cell interference. The overall spectral efficiency of the cellular system is not noise nor range limited, but interference limited. Inter-cell RRM uses multi-user MIMO techniques to coordinate resource allocation between different cell sites. The standard already defines several means of Inter-Cell Interference Coordination (ICIC), coordinated scheduling, Dynamic single-frequency networks, joint multi-cell precoding or multi-site MIMO are more examples for inter-cell RRM.

Today's existing technology bases RRM on traffic load, user positions, user mobility, QoS requirements, BS density, . . . and so on. Taking handover as an example, there has been numerous works around handover systems focusing on balancing the rate of blocking new call initiation vs handover failures given the different system parameters such as: the current handoff dropping rate, the traffic conditions, and the position of the users. A lot of today's RRM algorithms try to predict/learn the direction of the user based on past statistical information, behavioral patterns per UE, drop-offs rate, . . . etc.

Internet of Things (IoT) UEs, e.g. LTE-M and NB-IoT devices, are example of UEs that can be employed in the field to transmit information that are usually not time-critical; periodic transmissions within a certain time period specified by the client, every time they do their requested measurements, or if they accumulate the maximum amount information possible within their memory.

Those devices can be installed on moving vehicles/vessels to do measurements, track different parameters (stress, temperature, consumption, etc.). Such IoT devices may have a nearby more capable device that has a bigger energy resource, positioning information and access to third party geographical map applications; for example: measurement sensors onboard a train.

The U.S. patent application published as US2017272972A1 discloses an information handling system operating as a smart vehicle gateway and includes a wireless adapter for communicating with a wireless link and a storage device for storing a spatial-temporal user profile comprising wireless device usage trend data for a location in or near a predicted smart vehicle gateway path during a future time interval for a smart vehicle gateway. The smart vehicle gateway may operate to establish a wireless link on one of several WWAN link options as a home network via a programmable eSIM. The information handling system further includes positional detector and an application processor that determines a trajectory estimation during a future time interval. Such a system depends heavily on processing data, such as velocity and position, in what is described as a smart vehicle gateway (which is disclosed as a network node) to make predictions of a device's next location.

However, after insightful and inventive reasoning, the inventors have realized that today's solutions that are based on increasing the efficiency of RRM might be called dynamic, but they act after the fact by using “present” information once they become in the “past”. Furthermore, other solutions may be based on Machine Learning or other Artificial Intelligence based predictions to predict a device's future location or trajectory, but they come at the expense of the associated processing complexity.

There is thus a need for a manner to make predictions with higher accuracy and at minimum processing complexity.

Moreover, traditionally, LTE-M/NB-IoT devices can perform RRM measurements, however, it would require them to monitor the neighboring BSs, hence consume power. This means that those battery-powered devices will have to expand higher amounts of energy than needed. Reducing the monitoring and measurement load is also an area where improvement is needed.

### SUMMARY

As discussed above, the inventors have realized that there is a need for a more proactive manner of predicting future RRM needs that is not simply reacting to situations, and that is low on processing and running power.

An object of the present teachings is thus to overcome or at least reduce or mitigate the problems discussed in the above. According to one aspect there is provided a method for improved Radio Resource Management (RRM) for a User Equipment, UE, operating in a network comprising one or more first User Equipments, a second User Equipment and a network node, the method comprising: determining a dependency between the one or more first UEs and the second User Equipment; determining RRM settings for the second User Equipment; and determining RRM settings for the one or more first UEs based on the RRM settings for the second User Equipment.

Various aspects of a method for a network and of the network, and embodiments and implementations of aspects are disclosed in the description below as well as in the claims.

According to another aspect there is provided a network arranged for improved Radio Resource Management (RRM) for a User Equipment, UE, operating in said network, said network comprising one or more first User Equipments, a second User Equipment and a network node, the network being arranged to: determine a dependency between the one or more first UEs and the second User Equipment; determine RRM settings for the second User Equipment; and determine RRM settings for the one or more first UEs based on the RRM settings for the second User Equipment.

In one embodiment the second User Equipment is configured to determine the dependency between the one or more first UEs and the second User Equipment.

In one embodiment the network node is configured to determine the dependency between the one or more first UEs and the second User Equipment.

In one embodiment the network further comprises a remote device, wherein the remote device is configured to determine the dependency between the one or more first UEs and the second User Equipment.

In one embodiment the second User Equipment is configured to determine RRM settings for the second User Equipment. It should be noted that the second User Equipment determines RRM settings for the second User Equipment by processing data and generating settings that are provided as a proposal subject to approval by the network node.

In one embodiment the network node is configured to determine RRM settings for the second User Equipment.

According to another aspect there is provided a computer-readable medium carrying computer instructions that when loaded into and executed by a controller enables the controller to implement the method according to herein.

According to another aspect there is provided a method for a second UE providing improved Radio Resource Management (RRM) for a User Equipment, UE, operating in a network, said network comprising one or more first User Equipments, said second User Equipment and a network node, the method comprising: obtaining a dependency between the one or more first UEs and the second User Equipment; determining RRM settings for the second User Equipment for determining RRM settings for the one or more first UEs based on the RRM settings for the second User Equipment.

According to another aspect there is provided a second UE providing improved Radio Resource Management (RRM) for a User Equipment, UE, operating in a network, said network comprising one or more first User Equipments, said second User Equipment and a network node, the second User Equipment being configured to: obtain a dependency between the one or more first UEs and the second User Equipment; determine RRM settings for the second User Equipment for determining RRM settings for the one or more first UEs based on the RRM settings for the second User Equipment.

According to another aspect there is provided a computer-readable medium carrying computer instructions that when loaded into and executed by a controller of a second User Equipment enables the second User Equipment to implement the method according to herein.

According to another aspect there is provided a method for a first User Equipment for providing improved Radio Resource Management (RRM) for a User Equipment, UE, operating in a network, said network comprising one or more first User Equipments, a second User Equipment and a network node, the method comprising receiving RRM settings for the one or more first UEs based on RRM settings for the second User Equipment.

According to another aspect there is provided a first User Equipment for providing improved Radio Resource Management (RRM) for a User Equipment, UE, operating in a network, said network comprising one or more first User Equipments, a second User Equipment and a network node, the first User Equipment being configured to receive RRM settings for the one or more first UEs based on RRM settings for the second User Equipment.

In all aspects, the general proposed solution is to optimize the NW's resource usage (bandwidth and transmit power) and reduce UE energy consumption by advance planning of NW resource allocation and UE activity, given a route plan for one or more UEs moving along a trajectory that is predetermined or predictable using third-party app info. The proposed solution utilizes computational resources and information available at the NW for determining optimized UE activity timelines.

In one implementation type, the method can be implemented via a higher-level app that collects the information with an interface on both the UEs side and the NW side. On the UE side, such app will interact with third-party apps to collect UE travel info and UE physical layer information or RRM reporting information. On the NW side, the app will interface with the BS (or other NW node) RRM mechanisms.

Another way of realizing the proposed system is via incorporating this method in the standard to become part of the NW signaling, whereby the high-level app is not required.

The proposed solution is to optimize the NW's resource usage (BW and transmit power) and reduce UE energy consumption by advance planning of NW resource allocation and UE activity, given a route plan for one or more UEs moving along a trajectory that is predetermined or predictable using third-party app info. Solution utilizes computational resources and information available at the NW for determining optimized UE activity timelines.

In one implementation type, the system can be implemented via a higher-level app that collects the information with an interface on both the UEs side and the NW side. On the UE side, such app will interact with third-party apps to collect UE travel info and UE PHY layer or RRM reporting information. On the NW side, the app will interface with the BS (or other NW node) RRM mechanisms. The higher-level app is thus configured to handle the linking of the first and the second User Equipment and/or it processes the data, determines RRM settings and proposes them for final approval by the network node.

Another way of realizing the proposed system is via incorporating this method in the standard to become part of the NW signaling, whereby the high-level app is not required. The solution can be presented in four parts:
1) UE-assisted RRM for power-restricted devices (such as LTE-M or devices running low on power): A group of power-restricted devices (one or more first User Equipments) that are travelling together with a device, which has access to huge resources of power (second User Equipment), can have their resources management from the BS depend on the RRM measurements from the second User Equipment. Meaning that the second User Equipment will report to the BS the number of first User Equipments on board, and the BS may treat the second User Equipment and its identified first User Equipments as a one single UE with a big demand of resources; virtual UE. Establishing a dependency between one or more first User Equipments and second User Equipment can either happen via the following, but not limited to:
a. New standardized solution that dedicates signaling occasions to compare measurements between devices for a set period of time before establishing the dependency of the one or more first User Equipments slave devices on the second User Equipment device. The decision can be processed and communicated to one or more first User Equipments and/or second User Equipment either by the NW/BS side via the new standardized signaling or by the second User Equipment (via cellular or non-cellular). Other parameters that are considered in establishing the dependency includes, but not limited to, device HW, antennas, receivers, decoders, . . . etc.
b. Higher-level application that resides on the NW/BS/Cloud and runs on the second User Equipment, one or more first User Equipments and the NW where one or more first User Equipments capabilities (for example: device HW, antennas, receivers, decoders, . . . etc.) and RRM/mobility measurements (First data) and second User Equipment capabilities (for example: device HW, antennas, receivers, decoders, . . . etc.) and, route information (3rd party applications—flight schedules, trains, Google Maps, . . . etc.) and RRM/mobility measurements (Second data) are communicated to the NW/BS/Cloud via the application. The information can be all updated into a database that resides on the NW/BS/Cloud. Thus, information can be accessed and processed either via the second User Equipment or NW side and decisions are stored at the NW/BS/Cloud. Based on the results the NW makes a decision on the dependency between second User Equipment and one or more first User Equipments.

The linking of one or more first User Equipments to second User Equipment does not necessarily mean that the second User Equipment will share its measurements with the one or more first User Equipments, nor control them, but it is still an option.

If the virtual UE is approaching a BS that is not guaranteed to have enough resources to cover all the UEs within the virtual UE, the NW can prepare for that ahead of time using different scheduling mechanisms.
2) UE-assisted RRM & covering any device: Another approach for the proposed solution would be to leverage third party applications information such as, but not limited to, Google Maps, Waze, Skånetrafiken, flights schedule, Uber, Lyft, . . . etc. that can provide not only a prediction, but a confirmed intention of where the device is heading in terms of final destination. This will allow the NW to plan RRM not only across two BSs, but across all BSs that the device will go through based on the information from the third-party applications. During this period, either the device can skip the RRM measurements altogether or perform them at a reduced rate based on its data's sensitivity to latency (sensors vs smart phones) or when being at the edges of a cell for handover related issues. The BS can control the frequency of measurements in that case. If a change happens within the third-party apps' schedule or planned route, and/or actual measurements indicate deviation from the app-based schedule or route, this information is sent to the BS to modify the frequency at which the device would monitor the neighboring cells.
3) BS and UE-assisted for power save measures and resource management: An anticipated movement schedule for a group of UEs (e.g. a plane full of passengers) can be used to activate required NW resources, including turning on a necessary number of BS (or BS resources, e.g. carriers, antennas/panels). Furthermore, the movement schedule may be used to inform the UE about suitable NW resources at the destination ahead of time (before losing the connection on a flight), to reduce processing and energy consumption associated with initial NW access at the destination.
4) Unexpected Handover registry: The BS should keep a registry of all the unexpected handover procedures due to e.g. occasionally blocking scenarios related and correlated to certain events causing change in RF environments (like blocking events due to specific moving obstructive objects like trains entering a station blocking a small cell in certain areas, i.e. correlation of handover to specific events) to localize areas and future occasions with higher handover probability, and assign weights to the probability of a handover happening based on previous observations and future similar identified events (e.g. arrival of trains at station from third party APP). This should contribute into optimizing the future resource planning by the BS, i.e. it could 1) correlate the historical unexpected RF channel events e.g. to a 3rd party application (APP) showing train arrivals (root cause understood) and 2) Handle such future events better. The BS in this case would operate a software that could perform the followings, but not limited to, data base update, AI/M, big data analytics, . . . etc.

It should be noted that the use of a (third party) application for providing route information or other information for determining a dependency between UEs are applicable to all embodiments disclosed herein.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1 shows a schematic view of a User Equipment (UE) according to the teachings herein.

FIG. 2A shows a schematic view of a general network (NW) according to the teachings herein.

FIG. 2B shows a schematic view of a network node, exemplified as a base stations (BS) for example an eNode, according to the teachings herein.

FIG. 2C shows a schematic view of a network entity, exemplified as a Mobility Management Entity (MME), according to the teachings herein.

FIG. 3 shows a flowchart for a general method according to the teachings herein.

FIG. 4A shows a schematic view of a general situation according to the teachings herein.

FIG. 4B show a schematic view of a scenario for the general situation of FIG. 4A according to the teachings herein.

FIG. 4C show a schematic view of a scenario for the general situation of FIG. 4A according to the teachings herein.

FIG. 4D show a schematic view of a scenario for the general situation of FIG. 4A according to the teachings herein.

FIG. 4E show a schematic view of a scenario for the general situation of FIG. 4A according to the teachings herein.

FIG. 5 shows a schematic view of a computer-readable medium carrying computer instructions that when loaded into and executed by a controller of an arrangement, such as a User Equipment, enables the arrangement to implement an embodiment of the present invention.

### DETAILED DESCRIPTION

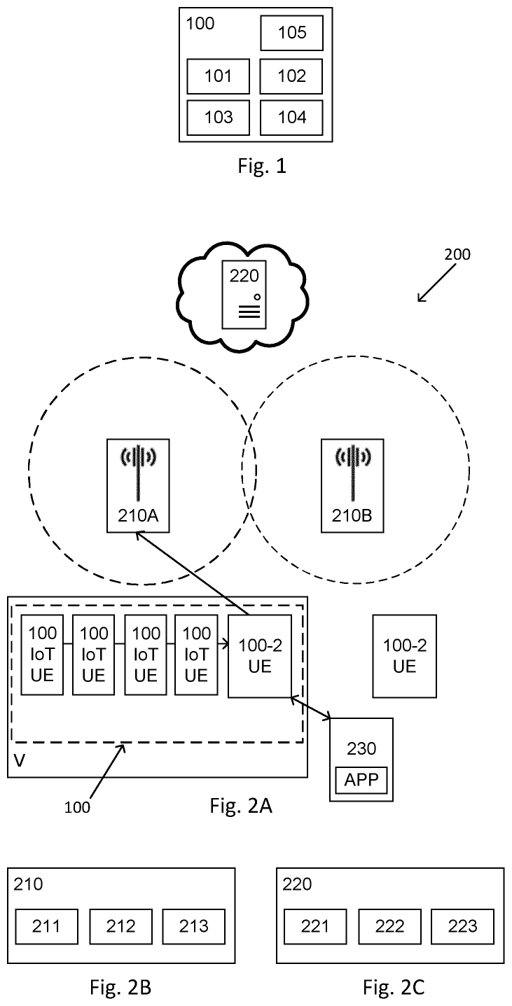

FIG. 1 shows a schematic view of a User Equipment (UE) 100 according to the teachings herein. The UE 100 comprises a controller 101, a memory 102, an interface 103, one or more sensors 104 and a power source 105. The controller 101 is configured to control the overall operation of the UE 100. In one embodiment, the controller 101 is a general purpose controller. In one embodiment, the controller 101 is a specific purpose controller. In one embodiment, the controller 101 is a combination of several general purpose controller and/or specific purpose controllers. As a skilled person would understand there are many alternatives for how to implement a controller, such as using Field-Programmable Gate Arrays circuits, ASIC, GPU, NPU etc. in addition or as an alternative. For the purpose of this application, all such possibilities and alternatives will be referred to simply as the controller 101.

The memory 102 is configured to store data such as sensor data, settings and computer-readable instructions that when loaded into the controller 101 indicates how the UE 100 is to be controlled. The memory 102 may comprise several memory units or devices, but they will be perceived as being part of the same overall memory 102.

As a skilled person would understand there are many possibilities of how to select where data should be stored in various memory units and a general memory 102 for the UE 100 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 102.

The communication interface 103 may be wired and/or wireless. The communication interface may comprise several interfaces. A user interface may be comprised in the communication interface 103 of the UE 100. Additionally or alternatively, (at least a part of) the user interface may be comprised remotely in the UE 100 through the communication interface 103, the user interface then (at least a part of it) not being a physical means in the UE 100, but implemented by receiving user input through a remote device (not shown) through the communication interface 103. One example of such a remote device is a game controller, a mobile phone handset, a tablet computer or a computer.

In one embodiment the communication interface 103 comprises a USB (Universal Serial Bus) interface. In one embodiment the communication interface 103 comprises a HDMI (High Definition Multimedia Interface) interface. In one embodiment the communication interface 103 comprises a Display Port interface. In one embodiment the communication interface 103 comprises an Ethernet interface. In one embodiment the communication interface 103 comprises a MIPI (Mobile Industry Processor Interface) interface. In one embodiment the communication interface comprises an analog interface, a CAN (Controller Area Network) bus interface, an I2C (Inter-Integrated Circuit) interface, or other interface.

In one embodiment the communication interface 103 comprises a radio frequency (RF) communications interface. In one such embodiment the communication interface 103 comprises a Bluetooth™ interface, a WiFi™ interface, a ZigBee™ interface, a RFID™ (Radio Frequency IDentifier) interface, Wireless Display (WiDi) interface, Miracast interface, and/or other RF interface commonly used for short range RF communication. In an alternative or supplemental such embodiment the communication interface 103 comprises a cellular communications interface such as a fifth generation (5G) cellular communication interface, an LTE (Long Term Evolution) interface, a GSM (Global Systéme Mobilé) interface and/or other interface commonly used for cellular communication. In one embodiment the communication interface 103 is configured to communicate using the UPnP (Universal Plug n Play) protocol. In one embodiment the communication interface 103 is configured to communicate using the DLNA (Digital Living Network Appliance) protocol.

In one embodiment, the communication interface 103 is configured to enable communication through more than one of the example technologies given above.

The communications interface 103 may be configured to enable the UE 100 to communicate with other devices, such as other UEs 100 such as smartphones, Internet tablets, computer tablets or other computers, media devices, such as television sets, gaming consoles, video viewer or projectors (not shown), or Internet of Things devices.

The one or more sensors 104 may comprise any sensors suitable for enabling the UE 100 operating as an IoT device, such as temperature sensor, humidity sensors, and acceleration sensors to mention a few examples.

The one or more sensors 104 may alternatively or additionally comprise sensors for determining a position of the UE 100, such as a satellite navigation device (for example GNSS or GPS).

The power source 105 may be a power connector arranged to connect to an external power source. Alternatively or additionally the power source 105 is a battery. The power source is associated with a power capability. The power capability may be limited by a batter life time or by the current being supplied by the external power source.

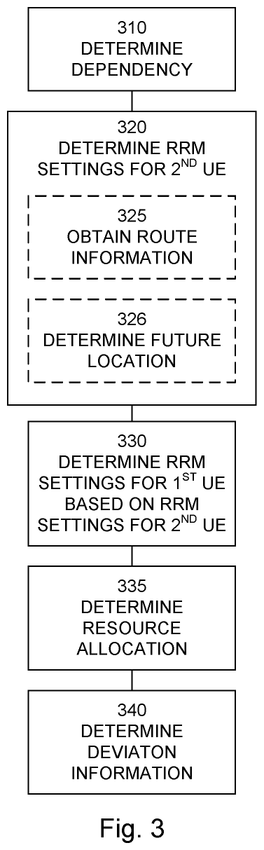

FIG. 2A shows a schematic view of a general network (NW) 200 according to the teachings herein. The network 200 comprises one or more network nodes 210, 220, such as one or more base stations (BS) 210 and/or one or more network entities 220, such as a Mobility Management Entity (MME), arranged for serving and providing telecommunications network capabilities to a plurality of User Equipments 100; at least a first User Equipment 100 and a second User Equipment 100-2. In one embodiment, the first User Equipment 100 is a grouping of more than one User Equipments 100. In one such embodiment the grouping of User Equipments 100 comprises a second UE 100-2 having high capabilities, as regards power capabilities of the power source 105, processing capabilities of the controller 101, memory space of the memory 102, bandwidth of the interface 103, and/or complexity of the sensor(s) 104, and one or more first UEs 100 having lower capabilities, where a low capability indicates a lower capability than the corresponding capability of a UE having high capabilities. Such UEs 100 having low capabilities are hereafter referred to as limited devices. One specific type of limited devices are devices with a limited power supply, such devices are hereafter referred to as power limited devices (PLDs) such as Internet of Things devices (IoTs). In the example of FIG. 2A, the first UE 100 is a grouping comprising a second UE 100-2 having high capabilities and a plurality (in this case 4) IoTs 100.

As would be known, a UE 100 may be arranged to execute various applications. One example of such applications are navigation applications capable of providing a current location of the UE, as well as providing a (proposed) route for the UE 100, and based on the route, a future location of the UE 100.

Applications may be executed locally, or they may be executed externally in a remote device 230 executing the same application APP. Commonly, an application is partially executed locally and partially externally.

The UEs 100 that are grouped may be grouped based on a spatial locality, such as travelling in the same vehicle V as in the example of FIG. 2A. There are different manners of determining the grouping and some will be discussed in further detail in the below.

FIG. 2B shows a schematic view of a network node 210, exemplified as a base stations (BS) for example an eNode, according to the teachings herein.

The BS 210 comprises a controller 211, a memory 212, and an interface 213. The controller 211 is configured to control the overall operation of the BS 210. In one embodiment, the controller 211 is a general purpose controller. In one embodiment, the controller 211 is a specific purpose controller. In one embodiment, the controller 211 is a combination of several general purpose controller and/or specific purpose controllers. As a skilled person would understand there are many alternatives for how to implement a controller, such as using Field-Programmable Gate Arrays circuits, ASIC, GPU, NPU etc. in addition or as an alternative. For the purpose of this application, all such possibilities and alternatives will be referred to simply as the controller 211.

The memory 212 is configured to store data such as settings and computer-readable instructions that when loaded into the controller 211 indicates how the BS 210 is to be controlled. The memory 212 may comprise several memory units or devices, but they will be perceived as being part of the same overall memory 212.

As a skilled person would understand there are many possibilities of how to select where data should be stored in various memory units and a general memory 212 for the BS 210 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 212.

In one embodiment the communication interface 213 comprises a radio frequency (RF) communications interface used for connecting a UE to a BS in cellular communication such as a fifth generation (5G) cellular communication interface, an LTE (Long Term Evolution) interface, a GSM (Global Systéme Mobilé) interface and/or other interface commonly in cellular communication.

FIG. 2C shows a schematic view of a network entity 220, exemplified as a Mobility Management Entity (MME), according to the teachings herein. The MME 220 comprises a controller 221, a memory 222, and an interface 223. The controller 221 is configured to control the overall operation of the MME 220. In one embodiment, the controller 221 is a general purpose controller. In one embodiment, the controller 221 is a specific purpose controller. In one embodiment, the controller 221 is a combination of several general purpose controller and/or specific purpose controllers. As a skilled person would understand there are many alternatives for how to implement a controller, such as using Field-Programmable Gate Arrays circuits, ASIC, GPU, NPU etc. in addition or as an alternative. For the purpose of this application, all such possibilities and alternatives will be referred to simply as the controller 221.

The memory 222 is configured to store data such as settings and computer-readable instructions that when loaded into the controller 221 indicates how the MME 220 is to be controlled. The memory 222 may comprise several memory units or devices, but they will be perceived as being part of the same overall memory 222.

As a skilled person would understand there are many possibilities of how to select where data should be stored in various memory units and a general memory 222 for the MME 220 is therefore seen to comprise any and all such memory units for the purpose of this application. As a skilled person would understand there are many alternatives of how to implement a memory, for example using non-volatile memory circuits, such as EEPROM memory circuits, or using volatile memory circuits, such as RAM memory circuits. For the purpose of this application all such alternatives will be referred to simply as the memory 222.

In one embodiment the communication interface 223 comprises a radio frequency (RF) communications interface used for connecting a MME to a BS in cellular communication such as a fifth generation (5G) cellular communication interface, an LTE (Long Term Evolution) interface, a GSM (Global Systéme Mobilé) interface and/or other interface commonly in cellular communication.

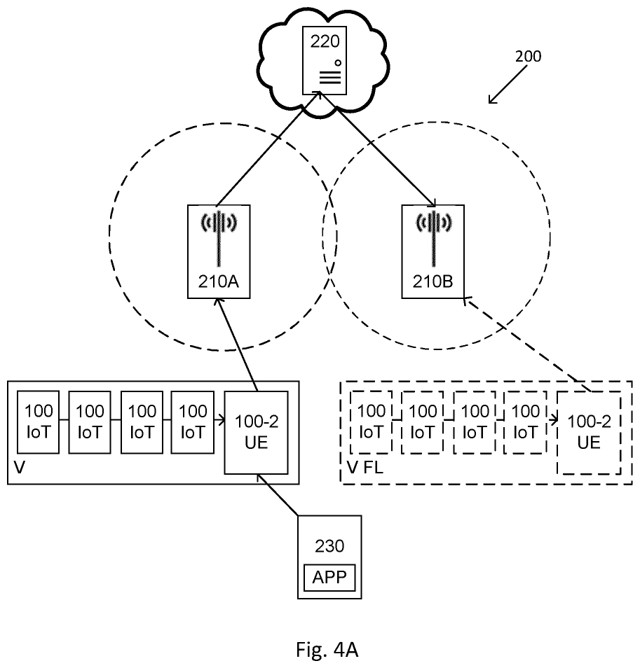

Referring to FIG. 2A and FIG. 3 showing a flowchart for a general method according to herein, there is provided a manner herein for improved Radio Resource Management (RRM) for User Equipments 100 operating in the network 200, wherein a dependency is determined 310 between one or more first UEs 100 and the second User Equipment 100-2.

Depending on the situation the second User Equipment 100-2 may be different user equipments. In one situation or embodiment, the second User Equipment 100-2 may be the second User Equipment 100-2 grouped with the IoTs 100 in the vehicle V, wherein low capability devices are linked to a high-capability device. In another or supplemental embodiment the second User Equipment 100-2 may be the not-linked second User Equipment 100-2 and the first User Equipment 100 may be the linked UEs or another User Equipment, wherein RRM settings are determined for a User Equipment based on another User Equipment regardless of the two user Equipments' capabilities based on a dependency between the two UEs. More details on determining a dependency will be discussed in the below.

RRM settings is determined 320 for the second User Equipment; and based on the RRM settings for the second User Equipment 100-2, the RRM settings for the one or more first UEs 100 are determined 330.

In one embodiment the RRM settings for the second User Equipment are based on route information for the second User Equipment 100-2. In one embodiment the method according to the teachings herein thus includes obtaining 325 route information for the second User Equipment 100-2. In one embodiment, the route information is obtained from the application (APP) possibly from the remote device 230, depending on where the application is being executed. as should be noted, and as has been discussed in the above, the application APP may be executed locally, externally or partially locally and partially externally even though only illustrated as being executed in the remote device 230.

In one embodiment the route information obtained is used to determine or predict 326 a future location for the second UE 100-2 and the RRM settings are determined based on and/or for the predicted future location, i.e. the RRM settings are related to the predicted future location. The future location is in one embodiment also associated with a time when the UE will be at that location. In such an embodiment, the predicted future location is seen as comprising both the location and the time when the UE will be at the location.

In one embodiment the determination of the RRM settings for the one or more first UEs 100 based on the RRM settings for the second User Equipment 100-2 comprises determining 335 a network resource allocation for the future location.

In one such embodiment, the determination 335 of a network resource allocation for the future location comprises determining RRM settings for a base station 210 at the future location for the second User Equipment 100-2 and updating an RRM configuration of the base station 210 at the future location enabling the base station 210 at the future location to operate accordingly (i.e. to operate according to the RRM configuration) as the second User Equipment 100 arrives at the future location in order to be able to handle predicted/expected transmission requirements. The base station 210 at the future location is thereby enabled to handle predicted or expected transmission requirements based on the RRM configuration.

In an alternative or additional such embodiment, determining 335 a reallocation of resources at the future location comprises storing information regarding said reallocation as part of allocation prediction information and determining said network resource allocation for the future location based on said allocation prediction information.

As seen in FIG. 2A, the first and second UE may be seen as one or more IoTs 100 grouped to a master (high capability) UE (acting as the second UE) or as a first UE 100 grouped to a second UE 100-2.

In one embodiment determining RRM settings for the one or more first UEs based on the second User Equipment comprises updating an RRM configuration of the second User Equipment based on the determined RRM settings for the second User Equipment and updating an RRM configuration of the first User Equipments based on the determined RRM settings for the second User Equipment. Not only is the RRM settings provided to the first UEs based on the RRM settings for the second UE, but the configurations of the UEs is also updated which enables the first UEs to operate in a similar manner to the second UE, but without having to determine the RRM settings, nor having the capability to do so or waste power in doing so.

The route of a UE may be determined in a number of ways. In general, the route information is determined initially for the second UE, possibly being the master UE. However, in some embodiments the route information may also or alternatively be based on the first UE, wherefore obtaining 325 route information for the second UE includes obtaining route information for the one or more first UEs.

As mentioned before, the route information may be available through an application. In one embodiment, the application is a travel application, which may be a third party application. The route information may also or alternatively be received from a remote device. The remote device 230 may be another UE or it may be a server for the app, i.e. be related to the app. The remote device 230 may also be a device aimed at a particular purpose. For example part of a shipping tracking system, wherein if a UE is noted to be travelling along with other UEs, those UEs may be grouped together and the determined route for the UEs may also be retrieved from the shipping tracking system.

In such embodiments, the remote device is related to at least one user of one of the one or more first User Equipments and/or the second User Equipment.

In order to dynamically plan for improved network usage, a deviation from the route may be detected, whereby deviation information regarding the deviation from the route information is determined 340 and the RRM settings are updated for the second User Equipment based on the deviation information, which also updates the RRM settings for the first UEs.

As noted above, the UEs 100 may be grouped by determining a dependency between the UEs 100. In one embodiment the dependency between at least one of the one or more first User Equipments 100 and the second User Equipment 100-2 is determined based on obtaining route information for the first UE 100 and matching the route information for the first UE 100 and the route information for the second User Equipment 100-2. If the two UEs have the same or very similar (within a threshold discrepancy) route information, they may be grouped. It should be noted that not only would the location is along the route be compared, but also the timing of the locations, i.e. when the UEs are to be at a specific location should match.

In one embodiment the dependency between at least one of the one or more first User Equipments 100 and the second User Equipment 100-2 is determined based on matching mobility measurements. If the two UEs have the same or very similar (within a threshold discrepancy) mobility measurements, they may be grouped.

And of course, the grouping may also be based on other aspects, such as belonging to the same shipping manifest (which could be seen as having the same route information) or having tickets for a same travel (which could be seen as having the same route information).

As discussed in the summary, the teachings herein may be seen as being applicable in four parts or scenarios.

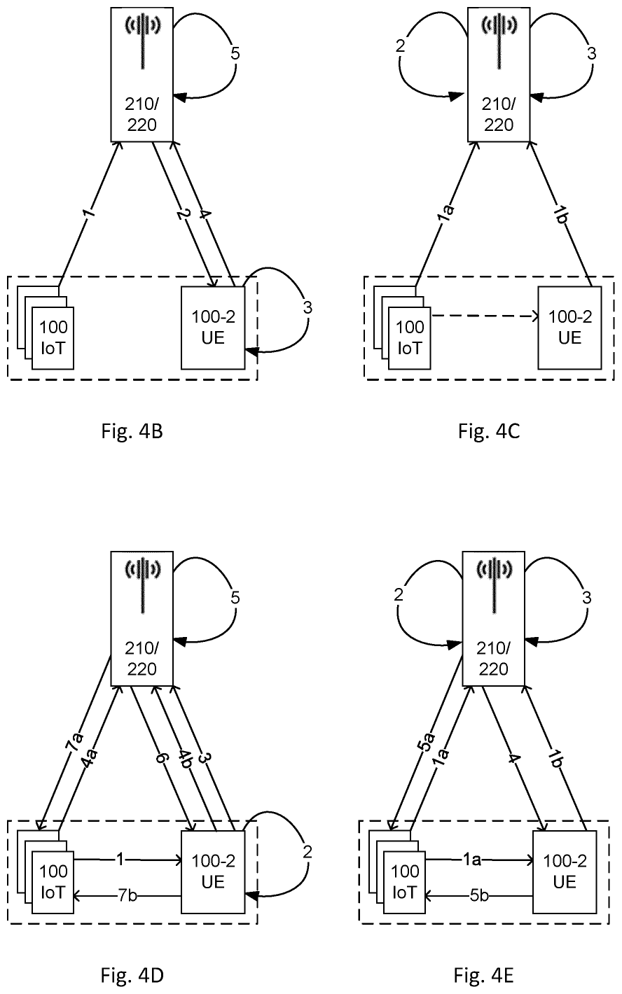

FIG. 4A is a schematic view of a general situation, and FIGS. 4B to 4E shows schematic views of different scenarios for the general situation of FIG. 4A.

Limited-power devices (slaves) that are travelling together with a device, which has access to huge resources of power (master), can have their resources management from the BS depend on the master's measurements. Meaning that the master will report to the BS the number of devices on board, and the BS would treat the master and its slaves as one big UE with a big demand for resources; Virtual UE. If the virtual UE is going into a BS that does not have enough resources to cover all the UEs within the virtual UE, the NW can prepare for that ahead of time using different scheduling mechanism. In such an example, the slaves are the first UEs 100 and the master is the second UE 100-2

The implementation of this example depends on the slaves' capabilities/complexity (available radios, HW such as microcontrollers and processors, . . . etc.) and RRM measurements. Thus, there are two main approaches to establish the dependency of the slaves on a certain master device:

The first approach comprises a Higher-level application that resides on the NW/BS/Cloud and runs on master, slaves and the NW where slaves' capabilities (for example: device HW, antennas, receivers, decoders, . . . etc.) and RRM measurements (First data) and master capabilities (for example: device HW, antennas, receivers, decoders, . . . etc) and RRM measurements (Second data) are communicated to the NW/BS/Cloud via the application. The information can be all updated into a database that resides on the NW/BS/Cloud. Thus, information can be accessed and processed either via the master or NW side and decisions are stored at the NW/BS/Cloud. Based on the results the NW makes a decision on the dependency between master and slaves.

The second approach relates to cases of very simple devices that cannot run high-level applications: New standardized solution or existing ones that dedicates signaling occasions to compare measurements between devices for a set period of time before establishing the dependency of the slave devices on the master device. The decision can be processed and communicated to slaves and/or master either by the NW/BS side via the new standardized signaling or by the master device (via cellular or non-cellular). Other parameters that are considered in establishing the dependency includes, but not limited to, device HW, antennas, receivers, decoders, . . . etc. Pacemakers are one example as they are very simple, and lack the capability to run higher-level applications. The advantage here is that it would be expected that the main UE (for example iPhone) of the pacemaker's user would always be in the vicinity, and hence can help the pacemaker in reducing its power consumption as described above.

Both manners can be used based on the slaves' capabilities. Security and privacy are not affected as slaves' information is not relayed through the master device. The master will act as a supporting agent to those devices either directly or via the BS to help them better utilize their limited resources.

FIG. 4A shows a scenario for a network 200 such as that of FIG. 2A, where a first base station 210A is in communication with—or at least connected to—a master UE 100-2. One or more power limited devices (PLDs) 100 are also shown, which may or may not be in communication with—or at least connected to—the first BS 210A. The one or more power limited devices (PLDs) 100 are linked to the master 100-2. In this example they are linked as being on the same vehicle V.

The scenario shown is thus one wherein the one or more first User Equipments 100 are Limited User Equipments having at least limited power capabilities and wherein the second User Equipment (100-2) has power capabilities exceeding the limited power capabilities. In this scenario the general method discussed above with reference to FIG. 3 further includes obtaining first data, i.e. capability data regarding the one or more first User Equipments 100 and obtaining second data, i.e. capability data regarding the master 100-2, i.e. the second User Equipment 100-2, wherein determining a dependency between the one or more first UEs (100) and the second

User Equipment (100-2) is based on the capability data. Also, the RRM settings for the second User Equipment are also determined based on the capability data regarding the second User Equipment (100-2). The capability data may be obtained along with the RRM settings for the corresponding device.

In one such embodiment and as discussed above the mobility measurements (as used for determining the dependency) are based on the capability data regarding the one or more first User Equipments 100 and the capability data regarding the second User Equipment 100-2.

As will be shown in FIGS. 4B to 4E, there are many manners of how the capability data may be obtained.

FIG. 4B shows a schematic view of actions taking place in a scenario where there is no connection between the slaves (the first UEs 100) and the master (the second UE 100-2), and where the determination regarding the dependency is performed by the master 100-2.

The procedure starts with the slaves providing information regarding their capabilities, i.e the first data, and transmits (1) this data to the NW (either to the base station 210 or to another NW entity 220), which in turn forwards (2) the first data to the master device, possibly after some partial processing or rearranging of the data. The master 100-2 already has access to its capability data, i.e. the second data (thereby obtaining it through local determinations). The master thus obtains both the first data and the second data. Based on this data, the master 100-2 determines (3) if there is a dependency between itself and the UEs for which the first data was received. The result of the determination on dependency is transmitted (4) to the NW along with the second data and any suggestions or specifics on suitable RRM settings. The NW then determines (5) the RRM settings based on the second data and the any suggestions or specifics on suitable RRM settings. The RRM settings are thus determined primarily based on the master (pending approval by the network). The NW then causes the UEs (both master and slaves) to update their settings according to the determined RRM settings if the RRM settings are approved by the NW.

FIG. 4C shows a schematic view of actions taking place in a scenario, similar to that of FIG. 4B where there is no connection between the slaves (the first UEs 100) and the master (the second UE 100-2), but where the determination regarding the dependency is performed by the network 210/220.

The procedure starts with the slaves providing information regarding their capabilities, i.e the first data, and transmits (1a) this data to the NW (either to the base station 210 or to another NW entity 220). At basically the same time, the master provides information regarding its capabilities, i.e the second data, and transmits (1b) this data to the NW. The network thus obtains both the first data and the second data. Based on this data, the network determines (2) if there is a dependency between the master and the UEs for which the first data was received. The NW then determines (3) the RRM settings based on the second data. The RRM settings are thus determined primarily based on the master. The NW then causes the UEs (both master and slaves) to update their settings according to the determined RRM settings if the RRM settings are approved by the NW.

FIG. 4D shows a schematic view of actions taking place in a scenario where there is a connection between the slaves (the first UEs 100) and the master (the second UE 100-2), and where the determination regarding the dependency is performed by the master 100-2.

The procedure starts with the slaves providing information regarding their capabilities, i.e the first data, and transmits (1) this data to the master. The master 100-2 already has access to its capability data, i.e. the second data (thereby obtaining it through local determinations). The master thus obtains both the first data and the second data. Based on this data, the master 100-2 determines (2) if there is a dependency between itself and the UEs for which the first data was received. The result of the determination on dependency is transmitted (3) to the NW (either to the base station 210 or to another NW entity 220) along with the second data and any suggestions or specifics on suitable RRM settings.

Alternatively, the first data may be transmitted (4a) from the first UEs 100 to the NW. Or the first data may be transmitted (4b) from the master to the NW. Alternatively, some first data is transmitted from the first UEs and some is transmitted from the master. The NW then determines (5) the RRM settings based on the second data and the any suggestions or specifics on suitable RRM settings. The RRM settings are thus determined primarily based on the master. The NW then causes (6) the master to update its settings according to the determined RRM settings. The NW also causes the UEs 100 to update their settings according to the determined RRM settings, either directly (7a) or through the master (7b).

FIG. 4E shows a schematic view of actions taking place in a scenario where there is a connection between the slaves (the first UEs 100) and the master (the second UE 100-2), and where the determination regarding the dependency is performed by the network.

The procedure starts with the slaves providing information regarding their capabilities, i.e the first data, and transmits (1a) this data to the master. The master 100-2 transmits (1b) its capability data, i.e. the second data, to the network (either to the base station 210 or to another NW entity 220). The first UEs 100 may transmit their first data directly to the NW, through the master, or alternatively partially directly and partially through the master. The network thus obtains both the first data and the second data. Based on this data, the network determines (2) if there is a dependency between the UEs for which the second data was received and the UEs for which the first data was received. The NW then determines (3) the RRM settings based on the second data. The RRM settings are determined primarily based on the master. The NW then causes (4) the master to update its settings according to the determined RRM settings. The NW also causes the UEs 100 to update their settings according to the determined RRM settings, either directly (5a) or through the master (5b).

As discussed above, the determination of the RRM settings is primarily based on the second UE. However, in order to provide RRM settings that are capable of being implemented by the limited first UEs, the the RRM settings for the second User Equipment 100-2 may also be determined based on the capability data regarding the one or more first User Equipments 100.

Also, as seen in FIGS. 4B and 4D, obtaining capability data regarding the one or more first User Equipments 100 comprises the second User Equipment receiving the capability data regarding the one or more first User Equipments 100 and determining the dependency between at least one of the one or more first User Equipments 100 and the second User Equipment 100-2 comprises the second User Equipment 100-2 determining the dependency.

Alternatively, as seen in FIGS. 4C and 4E, obtaining capability data regarding the one or more first User Equipments 100 comprises the network 210, 220 receiving the capability data regarding the one or more first User Equipments 100 and determining a dependency between at least one of the one or more first User Equipments 100 and the second User Equipment 100-2 comprises the network 210, 220 determining the dependency.

In all scenarios, determining RRM settings for the second User Equipment based on the capability data regarding the second User Equipment 100-2 comprises the network 210, 220 determining the RRM settings.

Furthermore, as seen in FIGS. 4B, 4C, 4D and 4E determining RRM settings for the second User Equipment may include the second user equipment 100-2 providing suggested RRM settings and the network 210, 220 deciding on (approving) the RRM settings to use in embodiments where the second User Equipment determines the RRM settings.

Returning to the second part of the invention, where two or more UEs of similar capabilities are grouped based on a third party application, some examples will be given.

As a first example, consider a user taking an overnight train heading from Malmö to Stockholm, and a train conductor scans the user's ticket. If the ticket is purchased using an application associated with the train service, the scanner can send the ticket's code (once the ticket is scanned) along with the unique UE ID to the server of the application or directly to the NW. This would transfer the information that this UE will be taking such and such trip for this period of time, i.e. the route information. Hence, the RRM for this UE can be predicted ahead of time for the next 7 hours or so. The UE can reduce the frequency of RRM related measurements between train stops, as the UE is limited in its mobility to the train tracks as the train is in motion. From the BS side, the RRM can now be better planned, and the UE can optimize the frequency of how often it needs to do its 3GPP-related measurements. Of course, this will apply to all users who get their electronic tickets scanned by the conductor's scanners, and so the UEs of all passengers can be grouped as there is a dependency between them as they share a route. Moreover, at each train station, the NW knows by virtue of the tickets scanned how many UEs are getting off at the station. Using this, the NW should be able to estimate how many UEs are on the train/vessel by a huge degree of accuracy, and the whole train can be viewed as one big “Virtual UE”. If any delays are reported by the train through the third-party application, then the NW will know that and adjust accordingly. Alternatively, the onboard GPS signal on board the train can be used to track the train's location in case of emergency stops or delays. for example, consider two trains that are leaving Malmö heading towards Stockholm and Gothenberg, respectively. By knowing the schedules of those two trains along with the number of devices onboard, which can be estimated based on the number of scanned traffic tickets that are reserved from Malmö to both destinations, the NW can then plan far into the future its resources accordingly, and increase/decrease UEs' signaling and monitoring occasions.

As a second example consider a passenger travelling on a highway and using a mapping application such as Google maps, WAZE, Lyft or UBER, . . . etc, this can be considered as an implicit expression of the UE's intended route and time frame. Hence, the BS can plan its resources accordingly. Through continuously sending information to the NW, any congestion information, accidents, or delays for any reason can be used to adjust the future resources plan accordingly. More specifically, Uber and Lyft users (both drivers and users) signal from their different perspectives when a trip starts and when a trip ends plus the route taken which is usually suggested by the app. All this information can be used to predict the future resources needs with a high degree of certainty.

As a third example, consider a transport truck carrying multiple sensors on board may make use of the invention to reduce the sensors power consumption. Linking between the sensors and the onboard master UE can happen via a higher-level app (for example: UPS package scanning system can pair a master UE on a certain transporter with the packages it will be carrying along a certain route).

Connecting with the second example, consider that there are cars travelling using navigation or mapping apps such as Google maps and Waze for navigation, respectively, while two trucks are also travelling in the same area, one being a DHL transporter and the other being a PostNord transporter. By having the third-party application information and combining the information from different third-party applications, the BSs can know far in time and with great accuracy when UEs are going into the cell's range and allocate resources accordingly. Using this information and the historical measurements log, the NW can better control the frequency of UEs' measurements occasions. If a device fails to follow the reported planned path, then the measurement frequency can go back to normal and the device falls back into regular operation mode until confirmation of future intentions are implicitly reported by the third-party app information. It is important to mention that data processing would regularly happen at the NW side, which also has RRM measurements information of UEs. In case this was to be performed at the cloud side, then it must be provided the RRM measurements for the devices under consideration.

Returning to the third part, consider the situation where there are BSs placed at airports gates or seaports. In Europe, most airports go offline after a certain hour. Hence, it would make sense to put BSs to sleep after certain hour. However, having the BSs go to sleep at a specific hour will not work in cases when some planes are being delayed and will be arriving late. As such, flight schedule updates can be used to manage when the BSs need to stay awake and when they can definitely go to sleep without causing any service disturbance or outage. Hence, the BS can anticipate needing enough resources to accommodate the number of UEs on board the plane once it lands and those users switch on their devices that will be looking for a signal. In such case, the UEs don't have to look for a BS really, as the NW (as an example) would immediately assign those UEs to the appropriate BS given their location and time of landing.

Within a single flight, the number of passengers is known accurately one hour before departure, based on everyone being checked in. The BS in that case knows how many resources will be available at a given point in time, which is once the plane has taken off and all those users are out of cellular coverage. Moreover, once the plane is landing at an airport, the number of passengers aboard the plane, and thus the number of UEs, is known ahead of time (since the plane took off). Hence, the BS can anticipate needing enough resources to accommodate the number of UEs on board the plane once it lands and those users switch on their devices that will be looking for a signal. In such case, the UEs will need to find cells but network would know most appropriate candidate cells and search could be limited. Even based on destination and if gates could be trusted (not to change during flight or if connection during flight) the UE could get this information a priori, as the NW would immediately assign those UEs to the appropriate BS given their location and time of landing. The devices will spend less time looking for a BS, which translates to less power consumption, and the BS will better manage its resources. Moreover, this would help the BS managing its sleep durations when no service will be required due to the fact that the airports would not be operating at certain hours. If a plane is delayed, then the BS can sleep and be waked by the network at the exact required time for service. This is not limited to user's phones really, but any cellular device (with different QoS requirements and lifetime expectancy) on board the flight.

Returning to the fourth part, consider a BS that can keep a registry of all the unexpected handover procedures due to e.g. occasionally blocking scenarios related and correlated to certain events causing change in RF environments (like blocking events due to specific moving obstructive objects like trains entering a station blocking a small cell in certain areas, i.e. correlation of handover to specific events) to localize areas and future occasions with higher handover probability, and assign weights to the probability of a handover happening based on previous observations and future similar identified events (e.g. arrival of trains at station from third party APP). This should contribute into optimizing the future resource planning by the BS. I.e. it could 1) correlate the historical unexpected RF channel events e.g. to a 3rd party application showing train arrivals (root cause understood) and 2) Handle such future events better.

Finally, in case this was done via the NW (standardized solution), there will be an information exchange mechanism between the third-party applications and the NW. The NW can fetch the corresponding information of the third-party application (e.g. travel schedule, QoS . . . ) for a certain UE from the application servers. So, the NW can inform the base stations along the travel route and schedule the proper radio resource for the UE. This could be either via an agreement between the applications owners and the NW, where downloading such app and allowing for the information to be shared to the NW would enhance the user's mobile experience and save them power on the long run. Another mechanism would be for the UE to send the user's information as long as they are within the user's rights. This can be promoted as saving energy for both the BS and users, saving time, and being more spectrally efficient on the BS side.

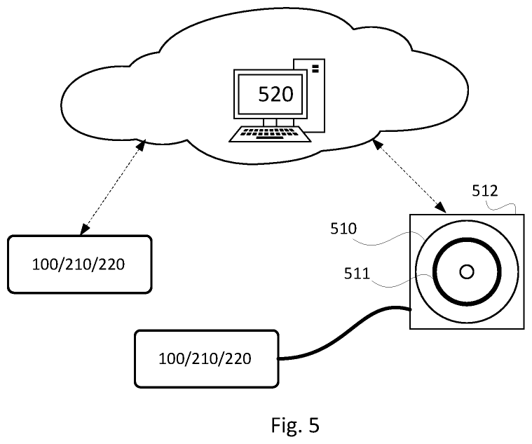

FIG. 5 shows a schematic view of a computer-readable medium 510 carrying computer instructions 511 that when loaded into and executed by a controller 101 of an arrangement, such as a User Equipment 100, enables the arrangement to implement an embodiment of the present invention.

The computer-readable medium 510 may be tangible such as a hard drive or a flash memory, for example a USB memory stick or a cloud server. Alternatively, the computer-readable medium 510 may be intangible such as a signal carrying the computer instructions enabling the computer instructions to be downloaded through a network connection, such as an internet connection.

In the example of FIG. 5, a computer-readable medium 510 is shown as being a computer disc 510 carrying computer-readable computer instructions 511, being inserted in a computer disc reader 512. The computer disc reader 512 may be part of a cloud server 520—or other server—or the computer disc reader may be connected to a cloud server 520—or other server. The cloud server 520 may be part of the internet or at least connected to the internet. The cloud server 520 may alternatively be connected through a proprietary or dedicated connection. In one example embodiment, the computer instructions are stored at a remote server 520 and be downloaded to the memory 102 of the UE 100 for being executed by the controller 101.

The computer disc reader 512 may also or alternatively be connected to (or possibly inserted into) an object detection arrangement 100 for transferring the computer-readable computer instructions 511 to a controller of the UE 100 (presumably via a memory of the object detection arrangement 100).

FIG. 5 shows both the situation when a UE 100 receives the computer-readable computer instructions 511 via a server connection and the situation when another UE 100 receives the computer-readable computer instructions 511 through a wired interface. This enables for computer-readable computer instructions 511 being downloaded into a UE 100 thereby enabling the UE 100 to operate according to and implement the invention as disclosed herein.

Even though the discussion herein regarding computer-readable mediums have been focused on UEs, the same applies to other network components such as base stations or network entities.

References to computer program, instructions, code etc. should be understood to encompass software for a programmable processor or firmware such as, for example, the programmable content of a hardware device whether instructions for a processor, or configuration settings for a fixed-function device, gate array or programmable logic device etc. The teachings herein provide numerous advantages. The main advantages are broken apart as follows:
A1) Reduction in the number of 3GPP-mandated connection management activities for devices with limited power resource, hence, these devices can consume less power to prolong their operation time and reduce the need to replace their batteries. For instance, major power savings in a constrained UE would result from the fact that the signals carrying mobility measurements and paging information will be processed by a less constrained UE and delivered to the more constrained UE or to the NW (to help better update the RRM configurations for the more constrained devices using the less constrained UE capabilities for finer and more encompassing measurements). In cases where the UEs are very simple and only has a connection to the BS, the more capable UE would interact with the BS to deliver the extra needed info for the optimization procedure (for example, the third-party app information). Moreover, it would free some of the cellular bandwidth for other users The key advantage, compared to prior art which focuses on reducing cellular data transmission, is that it proposes leveraging information from less constrained devices and use them for the more constrained devices to reduce the number of 3GPP-mandated communication procedures, hence, reducing power consumption of the seriously constrained devices, prolonging their operation time, and reducing the need to charge or replace their batteries. This could require either changes to the standard or running a higher-level application on the UEs and the NW. It is worth noting here that the gained advantage from Al should not be offset by the number of reconfigurations that may result from dynamically adjusting the RRM. This means that there would be a threshold that would indicate how many RRM adjustments while maintaining advantage Al. For example:
a. Less constrained UE measurements would indicate that there would be no need to update the configurations for a set period of time. This would mean that more constrained UE will not need to update their RRM configuration for the same period of time. This case resembles the absolute minimum gain from advantage A1.
b. The dynamic RRM reconfigurations are a result of the optimization calculations, hence, they will result in a lower power consumption overall. A way of guaranteeing that the system will not be switching the RRM configurations too often for the less constrained devices, is to skip every other measurement occasion and check for any RRM reconfigurations within the remaining measurement occasions.
A2) Leverage existing information data bases with minimum processing complexity to predict UE's behavior and location for long period ahead in time, which would reduce the uncertainty about Ues movement around the NW and help the NW in better planning its resources. Utilizing third-party app info constitutes a benefit compared to legacy (best-effort) estimation of the future trajectory based on neutral map and UE position info.
A3) Reduction in the power used by BS through optimizing their sleep periods without causing service interruptions/outages.

It is important here to realize that this provides varying degrees of certainty when it comes to predicting where the Ues are going to be in the next specific time window. However, it provides the Ues planed/intended mobility information. Certainty would be extremely high in cases of busses, trains, planes, . . . etc., however, it would provide a lesser degree of certainty when it comes to UES using mapping services as they have the freedom to change their route abruptly and ignore the maps services' suggestions.

1. A method for radio resource management (RRM) in a network comprising a first user equipment (UE), a second UE, and a network node, the method comprising:
determining a dependency between the first UE first UE and the second UE;
determining RRM settings for the second UE;
determining RRM settings for the first UE first UE based on the RRM settings for the second UE;
updating an RRM configuration of the second UE based on the determined RRM settings for the second UE; and
updating an RRM configuration of the first UE based on the determined RRM settings for the second UE.

2. The method according of claim 1, further comprising
obtaining route information for the second UE and
determining the RRM settings for the second UE based on the route information for the second UE.

3. The method of claim 2, wherein the RRM settings are related to a future location for the second UE based on the route information.

4. The method of claim 3, wherein determining RRM settings for the first UE comprises determining a network resource allocation for the future location for the second UE.

5. The method of claim 4, wherein determining a network resource allocation for the future location comprises;
determining RRM settings for a base station at the future location for the second UE; and
updating an RRM configuration of the base station at the future location.

6. The method of claim 4 , wherein the method further comprises:
determining a reallocation of resources at the future location;
storing information regarding said reallocation as part of allocation prediction information; and
determining said network resource allocation for the future location based on said allocation prediction information.

7-14. (canceled)

15. The method of claim 1, further comprising determining the dependency between the first UE and the second UE based on matching mobility measurements.

16. The method of claim 1, wherein
the first UE has first power capabilities,
the second UE has second power capabilities exceeding the power capabilities of the first UE,
the method further comprises:
obtaining capability data regarding the first UE;
obtaining capability data regarding the second UE;
determining a dependency between the first UE and the second UE based on the capability data; and
determining RRM settings for the second UE based on the capability data regarding the second UE.

17. The method of claim 15, wherein the mobility measurements are based on the capability data regarding the first UE and the capability data regarding the second UE.

18. The method of claim 16, further comprising
determining the RRM settings for the second UE also based on the capability data regarding the first UE.

19. The method of claim 16, wherein
obtaining capability data regarding the first UE comprises the second UE receiving the capability data regarding the first UE; and
determining the dependency between the first UE and the second UE comprises the second UE determining the dependency.

20. The method of claim 16, wherein
obtaining capability data regarding the first UE comprises the network node receiving the capability data regarding the first UE;
determining a dependency between at least one of the first UE and the second UE comprises the network node determining the dependency.

21. The method of claim 16, wherein
determining RRM settings for the second UE based on the capability data regarding the second UE comprises the network node determining the RRM settings.

22. The method of claim 16, wherein determining RRM settings for the second UE includes the second UE providing suggested RRM settings and the network node deciding on the RRM settings to use.

23. (canceled)

24. A network arranged for radio resource management (RRM), the network comprising:
a first user equipment (UE),
a second UE; and
a network node, wherein the network is arranged to:
determine a dependency the first UE and the second UE;
determine RRM settings for the second UE; and
determine RRM settings for the first UE based on the RRM settings for the second UE;
update an RRM configuration of the second UE based on the determined RRM settings for the second UE; and
update an RRM configuration of the first UE based on the determined RRM settings for the second UE.

25. The of claim 24, wherein the second UE is configured to determine the dependency between the first UE and the second UE.

26. The network of claim 24, wherein the network node is configured to determine the dependency between the first UE and the second UE.

27. The network of claim 24, further comprising a remote device, wherein the remote device is configured to determine the dependency between the first UE and the second UE.

28. The network of claim 24, wherein the second UE is configured to determine RRM settings for the UE.

29. The network of claim 24, wherein the network node is configured to determine RRM settings for the second UE.

30. (canceled)

31. A method performed by a second UE, the method comprising:
obtaining a dependency between a first UE and the second UE;
determining RRM settings for the second UE;
determining RRM settings for the first UE based on the RRM settings for the second UE;
updating an RRM configuration of the second UE based on the determined RRM settings for the second UE; and
updating an RRM configuration of the first UE based on the determined RRM settings for the second UE.

32. A second UE comprising:
memory; and
processing circuitry, wherein the memory stores instructions executable by the processing circuitry for configuring the second UE to perform a method comprising:
obtaining a dependency between a first UE and the second UE;
determining RRM settings for the second UE;
determining RRM settings for the first UE based on the RRM settings for the second UE;
updating an RRM configuration of the second UE based on the determined RRM settings for the second UE; and
updating an RRM configuration of the first UE based on the determined RRM settings for the second UE.

33. (canceled)

34. A method performed by a first user equipment (UE), the method comprising:
receiving radio resource management (RRM) settings for the first UE, wherein the RRM setting for the first UE were determined using RRM settings for a second UE.

35. A first user equipment (UE), the first UE comprising:
memory;
processing circuitry; and
a receiver for receiving radio resource management (RRM) settings for the first UE, wherein the RRM setting for the first UE were determined using RRM settings for a second UE.

36. (canceled)
